(19) United States
(12) Patent Application Publication
(10) Pub. No.: US 2005/0060160 A1
(43) Pub. Date: Mar. 17, 2005

(54) Hybrid automatic translation apparatus and method employing combination of rule-based method and translation pattern method, and computer-readable medium thereof

(76) Inventors: Yoon Hyung Roh, Taejon (KR); Sung Kwon Choi, Taejon (KR); Kiyoung Lee, Taejon (KR); Munpyo Hong, Taejon (KR); Cheol Ryu, Taejon (KR); Sang Kyu Park, Taejon (KR); Young Kil Kim, Taejon (KR); Chang Hyun Kim, Seoul (KR); Young Ae Seo, Taejon (KR); Seong Il Yang, Taejon (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/735,727

(22) Filed: Dec. 16, 2003

(30) Foreign Application Priority Data
Sep. 15, 2003 (KR) 2003-63517

(51) Int. Cl. G10L 21/00

(52) U.S. Cl. 704/277

(57) ABSTRACT

Disclosed are a hybrid automatic translation method and apparatus employing a combination of a rule-based method and a translation pattern method, and a computer readable medium thereof, which is capable of solving an ambiguity problem of the conventional rule-based method and a pattern generation and coverage problem of the translation pattern method. The hybrid automatic translation apparatus includes: a morpheme analyzing block for analyzing a morpheme of an inputted source sentence and determining parts of speech; a syntactic structure analyzing block for parsing the tagging result to output a parsing tree; a construction pattern generating block for extracting only a chunking result of phrases belonging to sub-category from the parsing tree to generate a construction pattern; a construction pattern translating block for translating the construction pattern by using a translation pattern; a clause structure analyzing block for analyzing a clause unit structure of the if the translation pattern matching of the construction pattern fails; and a partial pattern translating block for performing a pattern translation of partial construction pattern according to the result of the clause structure analysis to output a final translation result.

### BACKGROUND OF THE INVENTION

1. Field of the Invention

The present invention relates to an automatic translation method and apparatus, and a computer-readable medium thereof, and more particularly, to a hybrid automatic translation method and apparatus employing a combination of a rule-based method and a translation pattern method, and a computer readable medium thereof, which is capable of solving an ambiguity problem of the conventional rule-based method and a pattern generation and coverage problem of the translation pattern method.

2. Description of the Related Art

In case of a conventional rule-based machine translation method, as sentences become longer, there occurs a problem that degrades translation speed and performance due to an ambiguity explosion and an unlimited generation of a target sentence during a parsing.

In order to solve the above problem, there has been proposed an automatic translation method based on a translation pattern, in which predefined translation patterns are detected from source sentences. The automatic translation method based on the translation pattern has an advantage that an unlimited generation of target sentence is prevented and a translation quality is improved greatly.

According to the conventional automatic translation method based on the translation pattern, however, tagging and partial parsing are not enough to process an ambiguity that occurs until a construction pattern for translation is generated. Also, the conventional method cannot generate a correct construction pattern itself. Consequently, merits of the method based on the translation pattern are not exhibited sufficiently.

Additionally, as sentences become longer, the number of translation patterns to be established is increased rapidly and a matching success probability of the translation pattern is lowered, thereby causing a serious coverage problem.

Further, according to a typical long-sentence processing method, the coverage problem can be solved by dividing the long sentence into small units before a parsing. However, a performance limit and a side effect occur many times since the typical long-sentence division method is carried out using limited information prior to the parsing.

### SUMMARY OF THE INVENTION

Accordingly, the present invention is directed to a hybrid automatic translation method and apparatus, and a computer-readable medium thereof that substantially obviate one or more problems due to limitations and disadvantages of the related art.

An object of the present invention is to provide a hybrid automatic translation method and apparatus employing a combination of a rule-based method and a translation pattern method, and a computer-readable medium thereof, in which only a phrase chunking result is extracted from a syntactic analysis result, so that the ambiguity of the syntactic analysis and the side effect of the sentence division are minimized and the accuracy of the construction pattern generation for the translation pattern matching is increased. Further, if the pattern translation fails, only the clause structure is again analyzed to perform the partial pattern translation according to the clause sturcture analysis result, so that a high-quality translation result of a high coverage is obtained.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a hybrid automatic translation apparatus employing a combination of a rule-based method and a translation pattern method, includes: a morpheme analyzing block for analyzing a morpheme of an inputted source sentence; a tagging block for determining parts of speech with respect to the result of the morphological analysis; a syntactic structure analyzing block for performing a parsing to the tagging result to output a parsing tree; a construction pattern generating block for extracting only a chunking result of phrases belonging to sub-category of verb in the parsing tree to generate a construction pattern; a construction pattern translating block for translating the construction pattern by using a translation pattern; a clause structure analyzing block for analyzing a clausal structure of the construction pattern if the translation pattern matching of the construction pattern fails; and a partial pattern translating block for recognizing a partial construction pattern with respect to each sub-clause with reference to the result of the clause structure analysis, and performing a translation using a partial translation pattern.

In another aspect of the present invention, a hybrid automatic translation method employing a combination of a rule-based method and a translation pattern method, includes the steps of: (a) analyzing a morpheme of an inputted source sentence, performing a preprocessing chunking, and tagging the chunking result; (b) parsing the tagging result to output a parsing tree; (c) generating construction patterns by extracting only the chunking result of phrases belonging to sub-category of verb in the parsing tree; and (d) translating the construction pattern by using a translation pattern; (e) if the translation pattern matching to the construction pattern fails, analyzing a clausal structure of the construction pattern; and (f) generating a partial construction pattern with respect to sub-clause of translation failure node with reference to the result of the clause structure analysis, performing a pattern translation with respect to the partial construction pattern, and outputting a final translation result by combining the results of the pattern translation.

The step (f) includes the steps of: generating partial construction patterns with respect to sub-clause of a translation failure node with reference to the result of the clause structure analysis, and performing a pattern translation with respect to the partial construction pattern; replacing the translation result of the partial construction pattern with a sentence symbol “S”, and performing a pattern translation to the construction pattern reduced by the pattern replacement; and if the pattern translation using the reduced by the reduced construction pattern fails, generating a final translation result by performing a translation according to the construction components.

In further another aspect of the present invention, there is provided a computer-readable medium storing program instructions disposed on a computer to perform the hybrid automatic translation method employing the combination of the rule-based method and the translation pattern method.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing a configuration and a processing flow of a hybrid automatic translation apparatus and according to the present invention;

FIG. 2 is a configuration and a processing flow of the parsing block according to the present invention;

FIG. 3 is a flowchart showing the partial pattern translating process according to the present invention; and

FIG. 4 illustrates an example of the partial pattern translating process according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

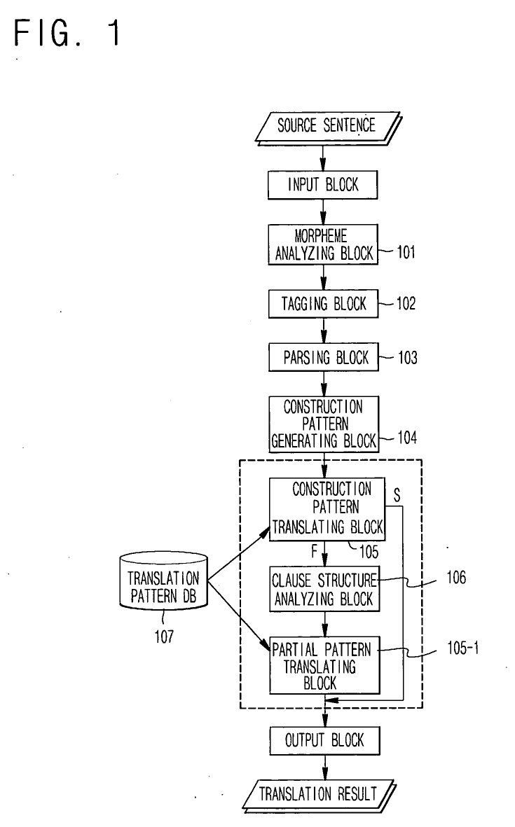

FIG. 1 is a block diagram showing an overall configuration and a processing flow of a hybrid automatic translation apparatus according to the present invention.

Herein, an overall operation of the hybrid automatic translation apparatus will be described with reference to FIG. 1.

Referring to FIG. 1, a morphological analysis and a tagging is performed to an inputted sentence (101, 102), and a parsing is performed to a sentence inputted as the tagging result (103). Then, a construction pattern is generated from a parsing tree created as the parsing result (104), and a translation is performed using the translation pattern (105).

Here, the construction pattern is a pattern that represents an entire sentence consisting of parts of speech, such as a main verb (V), an auxiliary verb (X) and a conjunction (C), and construction components depending thereon. Additionally, the construction components include a noun phrase (NP), a preposition phrase (PP), an adjective phrase (AP) and an isolated preposition phrase (IPREP), which will be represented by “n”, “p”, “a”, “i”, respectively.

According to the present invention, the construction pattern means a sentence-range pattern consisting of the parts of speech or the construction components, and it is different from a translation pattern in a general pattern-based method which uses phrase-range patterns. Additionally, it can generate the most appropriate target sentence with respect to the inputted sentence by describing a target construction pattern of a target sentence corresponding to the construction pattern. Here, the phrase-unit pattern having the translation information of the sentence range is referred to as a translation pattern. A translation method using the translation pattern can exhibit an improved performance when performing the translation between heterogeneous languages, such as English-to-Korean or Korean-to-English, of which languages are difficult to translate, requiring thorough syntactic analysis.

Further, in case the above-described translation using the translation pattern fails in the translation pattern matching, a clause structure analysis is performed (106), and a partial pattern translation is performed according to the result of the clause structure analysis (105-1).

According to the partial pattern translation, in case the translation pattern with respect to an entire sentence does not exist, the sentence is divided into partial construction patterns corresponding to sub-clauses, and the results are combined to generate a final result, thereby enhancing the coverage of the translation pattern.

The detailed blocks of the hybrid automatic translation apparatus according to the present invention will be described below in detail with reference to FIGS. 1 to 4.

Referring to FIG. 1, a morpheme analyzing block 101 performs a morphological analysis and a preprocessing chunking with respect to the inputted source sentence. The preprocessing chunking can reduce a length of the sentence and improve the tagging performance by combining in advance a proper noun, a time adverbial phrase, a vocabulary fixed expression, and the like.

The tagging block 102 performs the tagging to the morphological analysis to generate two optimum candidates with respect to each word, considering the tagging performance and the parsing efficiency. Accordingly, in case there is an ambiguity that the tagging alone is difficult to make distinction, the tagging performance can be improved by reflecting the wide-ranging parsing information through the parsing.

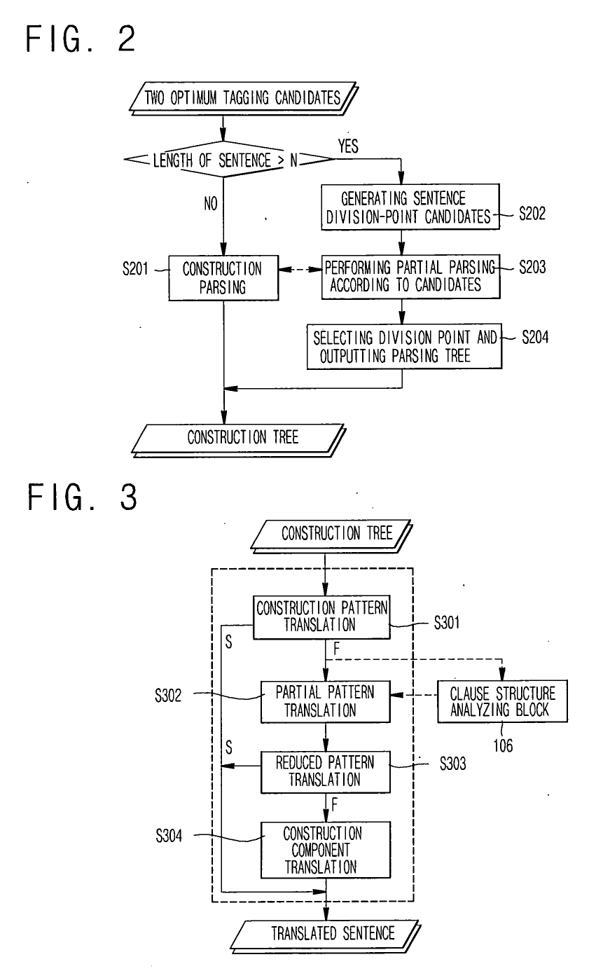

FIG. 2 is a detailed block diagram of the parsing block 103.

Referring to FIG. 2, the parsing block 103 performs the parsing to the two tagging optimum candidates inputted from the tagging block 102 (S201). A parsing with sentence division is performed if the inputted sentence is a long sentence, of which a length is more than a specific value N. At this time, the long sentence is determined by the length of the sentence after the preprocessing chunking.

Herein, the parsing with sentence division according to the present invention will be described below.

First, a plurality of sentence division-point candidates are selected based on the division-point syntactic clue, such as punctuation mark, conjunction, relative, and interrogatvie, in a sentence. Then, two or three division-point candidates are selected considering whether or not there is a main verb (i.e., a verb having a tense) on both sides of each divided sentence among the selected candidates, and a length of the divided sentence (S202).

A parsing is performed to the sentences divided by the division point according to the respective candidates (S203). If the divided sentence itself is a long sentence, a parsing is performed by recursively applying the steps S202 and S203. Like the foregoing case, an arbitrary long sentence can be divided as many as desired by again performing recursively the long sentence division to the divided sentence having a length larger than the specific value.

The optimum division point having a high weight is selected by applying parsing weights to the parsing results of the respective divided sentence, and a parsing result and a parsing tree according to the selected division point are outputted (S204).

Additionally, in order to find a portion, which must not be divided, such as an inserted clause, a context with a very wide range and a deep analysis are necessary. In this case, according to the present invention, the optimum division point can be determined more accurately, because a final division point is determined after the parsing is performed according to the candidates.

Herein, there is shown the sentence division parsing with respect to a following inputted sentence (an English sentence) according to an embodiment of the present invention.

[Inputted Sentence]: “We're told to look for an announcement under which the Russians would temporarily participate in the NATO command structure while the political leaders, including the two presidents when they speak today, try to work out the arrangements for a much broader Russian participation in the peacekeeping force.”

[Division-point candidates]: . . . in the NATO command structure/while the political leaders, including the two presidents/when they speak today, try to . . .

[Divided Sentence According to Each Division Point]

while: (We're told to look for . . . NATO command structure) (while the political leaders, including the two presidents when they speak today, try to . . . the peacekeeping force.)

when: (We're told to look for . . . NATO command structure while the political leaders, including the two presidents) (when they speak today, try to . . . in the peacemaking force.)

In case the division candidates is “when”, since the divided sentence “We're told to look for an announcement under which the Russians would temporarily participate in the NATO command structure while the political leaders, including the two presidents” is an abnormal sentence, the “when” is excluded from the division point candidates by the parsing weight.

[Parsing Result of Finally Selected Divided Sentence]

(S (NP We) (VP 're (VP told (TOINF (VP to (VP look_for) (NP an announcement) (PP under)))))) (SBAR (WHNP which) (SS (NP the Russians) (VP would temporarily (VP participate (PP in (NP the NATO command structure)))))))

(NP (NP the political leaders) -COMMA- (PP including (NP (NP the two presidents) (SBAR (WHADVP when) (SS (NP they) (VP speak today))))) -COMMA-) (VP try (TOINF to (VP work_out) (NP the arrangements) (PP for )NP (NP a (ADJP much broader) Russian participation) (PP in (NP the peacekeeping force)))))))

A construction pattern generating block 104 extracts the construction patterns by recognizing the chunking ranges of the phrases belonging to sub-category of verbs, such as NP, AP, PP and IPREP, in the parsing tree with respect to the finally selected division point candidate.

Here, the sub-category of verb represents a phrase depending on the verb among NP, AP, PP and IPREP in the syntacitc tree. Since an ambiguity increases with upper portion of the syntactic tree, the ambiguity problem of the parsing can be reduced by extracting the construction pattern using only the phrase chunking result of the sub-category.

The result of the phrase chunking extraction and the construction pattern with respect to the above illustrative sentence are shown below.

[Result of Phrase Chunking Extraction]

(NP We) 're told (IPREP to) look_for (NP an announcement) (IPREP under) which (NP the Russians) would temporarily participate (PP in the NATO command structure)

(NP the political leaders) -COMMA- try (IPREP to) work_out (NP the arrangements) (PP for a much broader Russian participation in the peacekeeping force)

[Pattern]: nViVniCnVpCnTpCnVTViVnp

In the above case, “while” is actually a conjugation within a relative clause of “under which” and a division point that must not be divided. Accordingly, if the translation is performed in a state that the sentence is divided by “while” according to the conventional method, an incorrect translation is produced. In other words, in the case of the convention method, the translation result is determined by the selection of the division point.

Unlike the conventional method, since the present invention extracts the construction patterns using only the phrase chunking result of the sub-category among the selected parsing results, the selection of the division point does not influence the construction pattern result, so that a correct clause structure is obtained through a clause structure analysis. Consequently, damage due to a failure of the sentence division is reduced.

Meanwhile, the construction pattern translation block 105 performs a pattern matching to the extracted construction pattern in a translation pattern DB 107. If the translation pattern matching to the entire construction pattern succeeds, the translation is performed by the corresponding translation pattern and the result is then outputted.

However, if the translation pattern matching to the construction pattern fails, a clause structure analyzing block 106 performs a clause structure analysis to the construction pattern.

The clause structure analysis is to check a structure of clause unit including a main verb within a sentence. The result of the clause structure analysis with respect to the illustrative sentence is shown below.

[Result of Clause Structure Analysis]

(s nViVniC(s (s nVp)C(s nT(p pC(s nV))TViVnp)))

A partial pattern translation block 105-1 performs the translation using the partial translation pattern based on the result of the clause structure analysis.

FIG. 3 is a process flowchart of the pattern translation according to the present invention.

Referring to FIG. 3, first, the translation pattern matching and translation is performed to the inputted construction pattern (S301). At this time, if the pattern translation succeeds, the result of the translation is outputted.

However, if the construction pattern translation fails, the clausal structure analysis is performed, and the partial construction pattern corresponding to the current child node in the clausal structure analysis tree is generated. At this time, in the case of a relative clause or an interrogate clause, a sentence restoration is performed so that the translation can be achieved using the existing translation pattern by restoring original construction components moved.

The pattern translation is performed to the generated partial construction pattern with reference to the pattern translation DB 107 (S302). At this time, if the pattern translation to the partial construction pattern fails, the partial pattern translation is again performed to the sub-clause with reference to the result of the clause structure analysis.

If the translation result of the partial construction pattern corresponding to the sub-clause is produced, it is replaced with a sentence symbol “S” containing the translation result of the corresponding range, and the final translation result is generated by performing the translation pattern matching and translation to the construction pattern reduced by the pattern replacement (S303).

If the translation using the reduced construction pattern fails, the translation is performed with the respective construction components constituting the construction pattern, such as NP, Verb, S (translated sub-clause) and AP, and the final translation result is generated by combining them (S304).

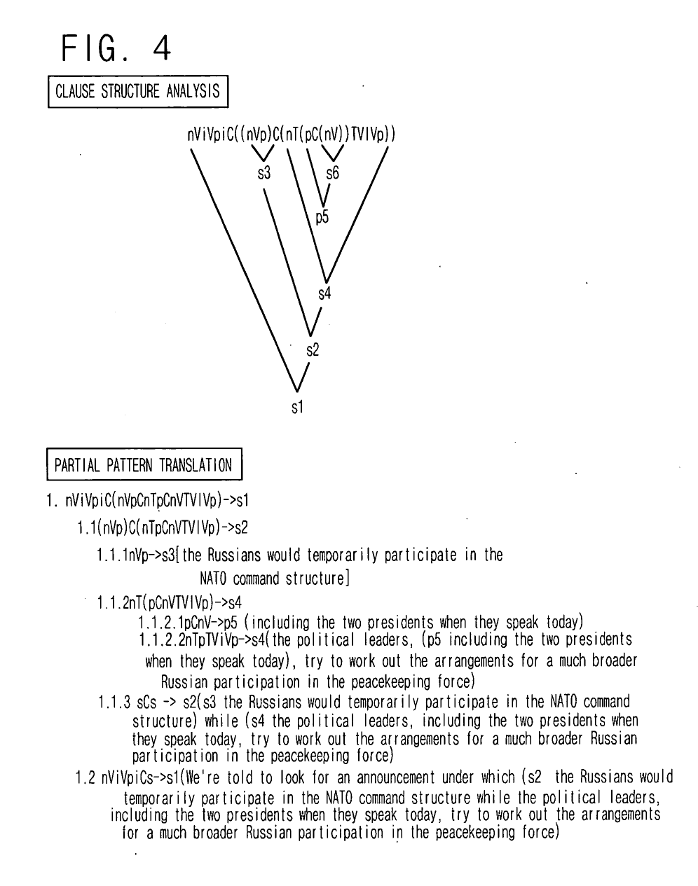

Meanwhile, FIG. 4 illustrates the result of the clause structure analysis and the partial pattern translation with respect to the inputted illustrative sentence.

Referring to FIG. 4, the pattern translation is tried with respect to “s1”. If it fails, the sub-clause “s2” is recognized from the result of the clause structure analysis, and the translation of s2 is tried in 1.1). At this time, if the translation with respect to s2 succeeds, the entire translation is performed by translating the reduced construction pattern as shown in 1.2).

If a direct translation with respect to the partial construction pattern of s2 fails, sub-clauses s3 and s4 are recognized from the result of the clause structure analysis, and the lower partial pattern translation is tried in 1.1.1), 1.1.2) and 1.1.3). If the pattern translation with respect to the lower translation pattern fails, the equal procedure is repeated with respect to the lower clause. Additionally, if the pattern translation with respect to the final sub-clause fails, the translation is tried according to the respective construction components.

According to the present invention, the partial pattern translation is performed in a top-down manner. Therefore, in case there exists the translation pattern in the upper structure even if there is an error in a clause structure analysis, a side effect due to an error in the clause structure analysis can be minimized.

Further, if there is no translation pattern with respect to the entire construction pattern, the pattern is matched with the partial construction pattern of the sub-clause and the reduced construction pattern, thereby reducing the length of the pattern to be matched and effectively improving the coverage of the translation pattern.

According to the present invention, the process unit of the structure analysis is divided into the phrase unit and the clause unit, and only the phrase unit result is extracted from the syntactic analysis result, thereby minimizing the ambiguity of the syntactic analysis and the side effect of the sentence division and increasing the accuracy of the construction pattern for the translation pattern matching.

Further, a high-quality translation result of a high coverage can be obtained by performing the partial pattern translation in a top-down manner from the result of the clause structure analysis.

It will be apparent to those skilled in the art that various modifications and variations can be made in the present invention. Thus, it is intended that the present invention covers the modifications and variations of this invention provided they come within the scope of the appended claims and their equivalents.

1. A hybrid automatic translation apparatus employing a combination of a rule-based method and a translation pattern method, the hybrid automatic translation apparatus comprising:
a morpheme analyzing block for analyzing a morpheme of an inputted source sentence;
a tagging block for determining parts of speech with respect to the result of the morphological analysis;
a syntactic structure analyzing block for performing a parsing to the tagging result to output a parsing tree;
a construction pattern generating block for extracting only a chunking result of phrases belonging to sub-category of verb in the parsing tree to generate a construction pattern;
a construction pattern translating block for translating the construction pattern by using a translation pattern;
a clause structure analyzing block for analyzing a clausal structure of the construction pattern if the translation pattern matching of the construction pattern fails; and
a partial pattern translating block for recognizing a partial construction pattern with respect to each sub-clause with reference to the result of the clause structure analysis, and performing a translation using a partial translation pattern.

2. The hybrid automatic translation apparatus of claim 1, wherein the morpheme analyzing block performs a preprocessing chunking when the morphological analysis of the inputted source sentence is performed.

3. The hybrid automatic translation apparatus of claim 1, wherein the tagging block outputs two optimum candidates as the tagging result to the syntactic structure analyzing block.

4. The hybrid automatic translation apparatus of claim 1, wherein the syntactic structure analyzing block selects two or three division point candidates based on divisional point syntactic clue, a presence of main verb, and a length of divided sentence, if the inputted sentence is a long sentence, a length of which is larger than a specific value, performs a parsing to the divided sentences according to the candidates, selects an optimum division point by applying parsing weights to the parsing result of the divided sentence, and outputs the syntactic parsing result according to the selected division point.

5. The hybrid automatic translation apparatus of claim 1, wherein the partial pattern translating block generates partial construction patterns with respect to sub-clause of a translation failure node with reference to the result of the clause structure analysis, performs a pattern translation to the partial construction pattern, replaces the translation result of the partial construction pattern with a sentence symbol “S”, performs a pattern translation with respect to the construction pattern reduced by the pattern replacement, and generates a final translation result by performing a translation according to the construction components if the pattern translation using the reduced construction pattern fails.

6. The hybrid automatic translation apparatus of claim 5, wherein the partial pattern translating block performs a top-down partial pattern translation, which performs a partial pattern translation to a sub-clause of the sub-clause, with reference to the result of the clause structure analysis, if the partial pattern translation of the sub-clause fails.

7. A hybrid automatic translation method employing a combination of a rule-based method and a translation pattern method, the hybrid automatic translation method comprising the steps of:
(a) analyzing a morpheme of an inputted source sentence, performing a preprocessing chunking, and tagging the chunking result;
(b) parsing the tagging result to output a parsing tree;
(c) generating construction patterns by extracting only the chunking result of phrases belonging to sub-category of verb in the parsing tree; and
(d) translating the construction pattern by using a translation pattern;
(e) if the translation pattern matching to the construction pattern fails, analyzing a clause unit structure of the ; and
(f) generating a partial construction pattern with respect to sub-clause of translation failure node with reference to the result of the clause structure analysis, performing a pattern translation with respect to the partial construction pattern, and outputting a final translation result by combining the results of the pattern translation.

8. The hybrid automatic translation method of claim 7, wherein the step (b) includes the steps of:
selecting two or three division point candidates based on divisional point syntactic clue, a presence of main verb, and a length of divided sentence if the inputted sentence is a long sentence, a length of which is larger than a specific value;
performing a parsing to the divided sentences according to the candidates; and
selecting an optimum division point by applying parsing weights to the parsing result of the divided sentence, and outputting the syntactic parsing result according to the selected division point.

9. The hybrid automatic translation method of claim 7, wherein the step (f) includes the steps of:
generating partial construction patterns with respect to sub-clause of a translation failure node with reference to the result of the clause structure analysis, and performing a pattern translation with respect to the partial construction pattern;
replacing the translation result of the partial construction pattern with a sentence symbol “S”, and performing a pattern translation to the construction pattern reduced by the pattern replacement; and
if the pattern translation using the reduced by the reduced construction pattern fails, generating a final translation result by performing a translation according to the construction components.

10. The hybrid automatic translation method of claim 9, wherein if the partial pattern translation of the sub-clause fails, the step (f) performs a top-down partial pattern translation, which performs a partial pattern translation with respect to a sub-clause of the sub-clause, with reference to the result of the clause structure analysis.

11. A computer-readable medium storing program instructions, the program instruction being disposed on a computer to perform the method claimed in claim 7.

12. A computer-readable medium storing program instructions, the program instruction being disposed on a computer to perform the method claimed in claim 8.

13. A computer-readable medium storing program instructions, the program instruction being disposed on a computer to perform the method claimed in claim 9.

14. A computer-readable medium storing program instructions, the program instruction being disposed on a computer to perform the method claimed in claim 10.
